(19) United States
(12) Patent Application Publication
(10) Pub. No.: US 2010/0300417 A1
(43) Pub. Date: Dec. 2, 2010

(54) INTERNAL COMBUSTION ENGINE HAVING A TRANSITIONALLY SEGREGATED COMBUSTION CHAMBER

(76) Inventor: David J. Schouweiler, JR., Minneapolis, MN (US)

Correspondence Address: SCHWEGMAN, LUNDBERG & WOESSNER, P.A., P.O. BOX 2938, MINNEAPOLIS, MN, 55402, US

(21) Appl. No.: 12/794,534

(22) Filed: Jun. 4, 2010

Related U.S. Application Data
(63) Continuation-in-part of application No. 12/334,164, filed on Dec. 12, 2008.
(60) Provisional application No. 61/184,118, filed on Jun. 4, 2009.
(60) Provisional application No. 61/239,201, filed on Sep. 2, 2009.
(60) Provisional application No. 61/241,774, filed on Sep. 11, 2009.
(60) Provisional application No. 61/290,799, filed on Dec. 29, 2009.
(60) Provisional application No. 61/322,069, filed on Apr. 8, 2010.

(51) Int. Cl. F02B 23/00; F01L 3/00; F01L 7/00; F02B 75/08

(52) U.S. Cl. 123/661; 123/188.2; 123/190.1; 123/668

(57) ABSTRACT

A combustion chamber is provided within an internal combustion engine, the combustion chamber including a cylinder head having an internal bore with an open end and a closed end, and a piston which reciprocates within the internal bore between a TDC position near the closed end and a BDC position, with a compression end facing the closed end. Poppet valves on the closed end and ports on the internal bore can control the flow of gasses into, and from, the combustion chamber. The combustion chamber is stratified when the compression end is positioned within a stratified distance of the closed end. When stratified, the combustion chamber is comprised of a central combustion region, a perimeter squish region, and a transfer passage between the regions. A direct fuel injector injects fuel into the central combustion region, mixing fuel with inducted gasses prior to combustion. The combustion chamber can be thermally insulated.

### CLAIM OF PRIORITY

The present application is a Continuation-in-Part of U.S. patent application Ser. No. 12/334,164, filed Dec. 12, 2008, and also claims priority under 35 U.S.C. 119(e) to U.S. Provisional Patent Application Ser. No. 61/184,118, filed Jun. 4, 2009, to U.S. Provisional Patent Application Ser. No. 61/239,201, filed Sep. 2, 2009, to U.S. Provisional Patent Application Ser. No. 61/241,774, filed Sep. 11, 2009, to U.S. Provisional Patent Application Ser. No. 61/290,799, filed Dec. 29, 2009, and to U.S. Provisional Patent Application Ser. No. 61/322,069, filed Apr. 8, 2010, all of which are hereby incorporated by reference in their entirety.

The present application is related to U.S. Provisional Patent Application Ser. No. 61/013,900, filed Dec. 14, 2007, and is related to U.S. Provisional Patent Application Ser. No. 61/013,903, filed Dec. 14, 2007, all of which are hereby incorporated by reference in their entirety.

### TECHNICAL FIELD

The present application relates to internal combustion engines, and in particular to methods and apparatus for a stratified combustion chamber in an internal combustion engine.

### BACKGROUND

There is an ongoing effort to improve fuel mileage in motor vehicles. In the last half century, fuel mileage improvements from internal combustion engines have most often been a result of increased volumetric efficiency (i.e., increased horsepower per unit volume of cylinder displacement), not increased thermal efficiency.

Higher volumetric efficiency in modern engines does not indicate improved thermal efficiency in an engine. For example, an older 80 horsepower 2 liter engine and a modern 160 horsepower 2 liter engine will likely provide about the same fuel mileage in a particular small car application.

Small displacement engines with high volumetric efficiency operate at higher combustion chamber temperature and pressure and higher RPM than do similarly tasked large displacement engines, reducing combustion chamber surface area and reducing exposure time in which each expansion event can lose heat energy to a cooling system. These conditions keep a 160 horsepower 2 liter engine within a more thermally efficient segment of its operating range when matched to a large vehicle, leading to better fuel mileage than achievable with a 160 horsepower 4 liter engine in the same large vehicle.

Fuel mileage gains may become tougher to find as small engines more routinely populate large vehicles. Atkinson engines, which achieve improved thermal efficiency through reduced volumetric efficiency, are found in some of the most fuel efficient cars today. HCCI engine development programs, now popular in laboratories around the world, seek high thermal efficiency using a process which has low volumetric efficiency.

Unconventionally cool exhaust temperatures and unconventionally high levels of molecular oxygen in the exhaust of high thermal efficiency engines will render many conventional emissions control devices inoperative, requiring that measures be taken to prevent the formation of combustion pollutants. What is needed is an improved method and apparatus to prevent the formation of combustion pollutants, minimizing the need for pollution control devices in high thermal efficiency engines.

### SUMMARY

The present subject matter provides apparatus and methods for a transitionally stratified combustion chamber in an internal combustion engine. The apparatus includes a combustion chamber assembly within a direct-injected internal combustion engine. The combustion chamber assembly includes a cylinder head assembly having an internal bore with an open end, a closed end, and an external block, and a piston assembly reciprocating within the internal bore between a top dead center (TDC) position near the closed end and a bottom dead center (BDC) position. The piston assembly has a compression end facing the closed end, an outside diameter, a groove located at the outside diameter and located a crevice distance from the compression end, and a sealing ring positioned in the groove. The compression end, the internal bore, and the closed end, together form the bounds of a combustion chamber whose volume is dependent on the position of the piston. The combustion chamber transitions from unstratified to stratified each time the compression end travels from BDC to TDC and reaches a stratified distance from the closed end, and the combustion chamber transitions from stratified to unstratified each time the compression end travels from TDC to BDC and reaches the stratified distance from the closed end. The combustion chamber, when stratified, includes a central combustion region, a perimeter squish region, and a transfer passage between the regions.

Stratification keeps the perimeter squish region of the combustion chamber devoid of direct-injected fuel to minimize hydrocarbon (HC) pollution emissions formed in areas of the combustion chamber which don't support efficient combustion, and permits creating a central combustion region specifically designed to combust efficiently and cleanly. Stratification additionally permits selection of a fuel-air equivalence ratio which combusts quickly and completely. A direct fuel injector is positioned at the closed end to inject fuel into the central combustion region of the stratified combustion chamber. The direct fuel injector begins direct injecting fuel during a segment of the compression cycle after stratification begins and ends direct injecting fuel prior to the start of combustion. There is a period of turbulent fuel-air mixing in the central combustion region from the end of direct fuel injection until combustion begins, with turbulent kinetic energy substantially provided by the transfer of inducted gasses from the perimeter squish region to the central combustion region via the transfer passage. One or more poppet valves on the closed end and one or more ports on the internal bore can control the flow of gasses into, and from, the combustion chamber. The compression end can have on it a layer of combustion-resistant thermally insulating material affixed to the center and extending outward, and can extend as far as the outside diameter and then toward the sealing ring. The closed end can have on it a layer of combustion-resistant thermally insulating material affixed to the center and extending outward, and can extend as far as the internal bore, and then toward, but not reaching, the sealing ring at TDC. The distance the thermally insulating material travels down the cylinder bore, if any, is called an insulating distance.

The combustion chamber predominantly thermally insulates when the compression end is positioned less than the insulating distance of the closed end. The combustion chamber partially thermally insulates when the compression end is positioned greater than the insulating distance from the closed end, such that the thermally conductive segment of the internal bore is directly exposed to combustion chamber gasses. The thermally insulating segments, if present, exist to reduce heat energy conduction into the cooling system, and to elevate the combustion chamber surface temperature during combustion to minimize carbon monoxide (CO) pollution emissions.

This summary is an overview of some of the teachings of the present application and is not intended to be an exclusive or exhaustive treatment of the present subject matter. Further details about the present subject matter are found in the detailed description and the appended claims. The scope of the present invention is defined by the appended claims and their equivalents.

### BRIEF DESCRIPTION OF DRAWINGS

FIG. 1 is an isometric section view of an internal combustion engine's cylinder head assembly, according to one embodiment of the present subject matter.

FIG. 2 is a front section view of the assembly of FIG. 1, shown with the piston at an intermediate position between TDC and BDC, according to one embodiment of the present subject matter.

FIG. 3 is a partial view of the assembly of FIG. 2, shown with the piston at the position which transitions the combustion chamber between non-stratified and stratified, according to one embodiment of the present subject matter.

FIG. 4 is a partial view of the assembly of FIG. 2, shown with the piston at the position which transitions the combustion chamber between partially thermally insulating and predominantly thermally insulating, according to one embodiment of the present subject matter.

FIG. 5 is a partial view of the assembly of FIG. 2, shown with the piston at TDC, with the combustion chamber shaped to combust quickly and cleanly, according to one embodiment of the present subject matter.

FIG. 6 is an isometric view of a rotary drum valve assembly mounted to the external block, according to one embodiment of the present subject matter.

FIG. 7 is an isometric section view of the assembly of FIG. 6, shown with the piston positioned at BDC, according to one embodiment of the present subject matter.

FIG. 8 is a front section view of the assembly of FIG. 7, according to one embodiment of the present subject matter.

### DETAILED DESCRIPTION

The following detailed description of the present invention refers to subject matter in the accompanying drawings which show, by way of illustration, specific aspects and embodiments in which the present subject matter may be practiced. These embodiments are described in sufficient detail to enable those skilled in the art to practice the present subject matter. References to “an”, “one”, or “various” embodiments in this disclosure are not necessarily to the same embodiment, and such references contemplate more than one embodiment. The following detailed description is, therefore, not to be taken in a limiting sense, and the scope is defined only by the appended claims, along with the full scope of legal equivalents to which such claims are entitled.

Unconventionally cool exhaust temperatures in high thermal efficiency engines will render many conventional emissions control devices inoperative, requiring that measures be taken to prevent the formation of combustion pollutants. Stratification of fuel in the combustion chamber can prevent the formation of some types of combustion pollutants in these applications. Selective thermal insulation of the combustion chamber can prevent other forms of combustion pollutants, minimizing the need for pollution control devices in high thermal efficiency engines.

Certain combustion chamber volumes do not efficiently support combustion, including, for example, the crevice surrounding the head sealing gasket and the perimeter junction between the intake poppet valve and the poppet valve seat. These crevice volumes generate HC combustion pollutants which must be controlled. An effective solution to this combustion pollution issue is to employ combustion chamber stratification, in conjunction with the specialized timing of direct injected fuel, to prevent soot emissions while keeping fuel out of combustion chamber locations which don't support efficient combustion.

The present subject matter provides a combustion chamber assembly for an internal combustion engine. According to various embodiments, the combustion chamber assembly includes a cylinder head assembly including an internal bore, an open end and a closed end. The combustion chamber assembly also includes a piston assembly reciprocating within the internal bore between a top dead center (TDC) position near the closed end and a bottom dead center (BDC) position, the piston assembly having a compression end facing the closed end, according to various embodiments. The combustion chamber is bounded by the compression end, the closed end, and the internal bore, in an embodiment. According to various embodiments, the combustion chamber is adapted to become stratified to include a central combustion region and a perimeter squish region each time the compression end reaches a stratified distance from the closed end while traveling from BDC toward TDC, and the combustion chamber is adapted to include a single region each time the compression end reaches the stratified distance from the closed end while traveling away from TDC. The perimeter squish region is also referred to as a perimeter region herein. Various embodiments include a transfer passage between the central combustion region and the perimeter squish region, the transfer passage adapted to transfer inducted gasses from the perimeter squish region to the central combustion region prior to combustion, and adapted to transfer combusted gasses from the central combustion region to the perimeter squish region after combustion. According to various embodiments, the transfer passage is an annular transfer passage. Other transfer passage shapes can be used without departing from the scope of this disclosure.

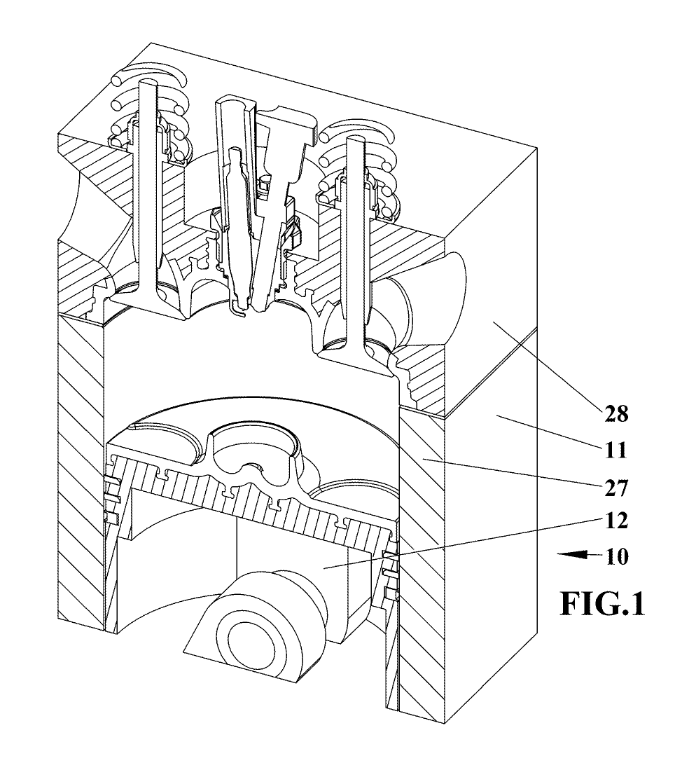

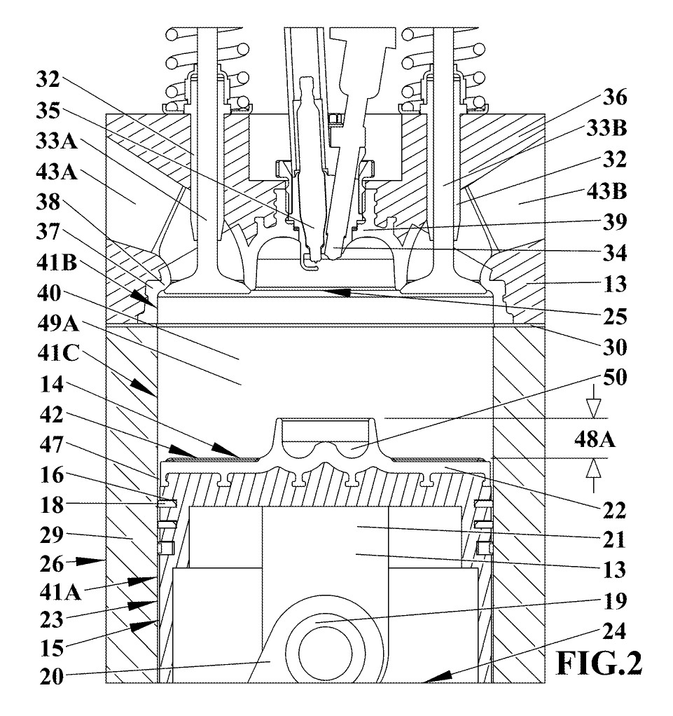

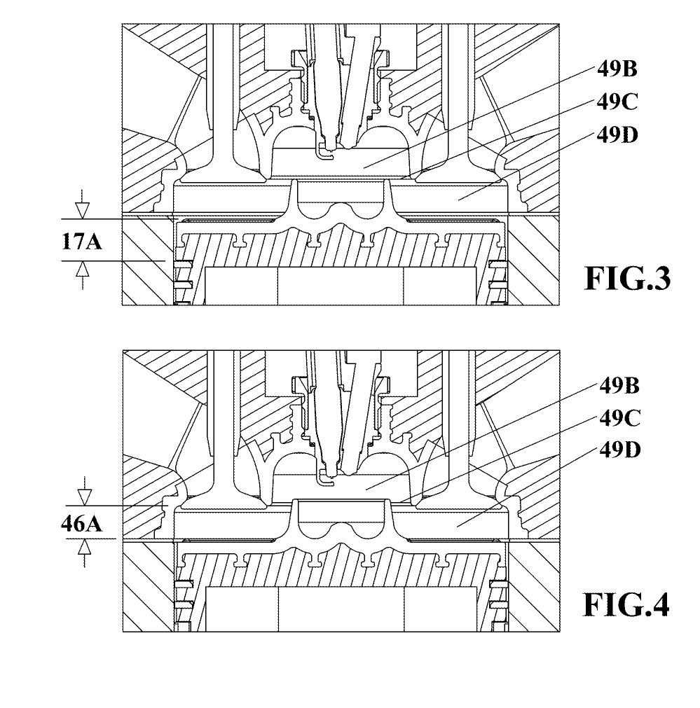

FIG. 1 shows the features of a combustion chamber assembly 10 within an internal combustion engine, according to various embodiments of the present subject matter. Typically, an engine for a vehicle will have four, five, six, or eight cylinder head assemblies cooperatively driving a single crankshaft. The combustion chamber assembly 10 is in many ways similar to a single combustion chamber assembly in a conventional engine. The combustion chamber assembly 10 includes a cylinder head assembly 11 and a piston assembly 12. FIGS. 2 and 3 show the piston assembly 12 including a composite piston 13, a compression end 14, an outside diameter 15, a groove 16, a crevice distance 17A, a sealing ring 18, a wrist pin 19, and a connecting rod 20, according to an embodiment. The composite piston 13 includes a cast aluminum piston 21, and a combustion resistant thermally insulating cap 22. According to various embodiments, the cylinder head assembly 11 contains an internal bore 23, an open end 24, a closed end 25, and an external block 26, and includes a cylinder assembly 27 and a head assembly 28. The cylinder assembly 27 includes a cast iron cylinder 29 and a sealing gasket 30, in various embodiments. According to various embodiments, the head assembly 28 includes a composite head 31, poppet valve guides 32, intake poppet valve 33A, exhaust poppet valve 33B, direct fuel injector 34, and spark plug 35. The composite head 31 includes a cast aluminum head 36, and a combustion resistant thermally insulating dish 37, in various embodiments. The combustion resistant thermally insulating dish 37 integrates poppet valve seats 38 and a direct fuel injector mount 39 as features of its construction, in an embodiment. Some embodiments may not integrate these two features, but may instead incorporate discrete poppet valve seats 38 and a discrete fuel injector mount 39 positioned adjacent to the thermally insulating dish 37.

In this context, “combustion-resistant” for a material means that the material is inert over perhaps as many as 10̂9 individual combustion events (power strokes), which corresponds to thousands of hours of engine operation, and can resist pressures in the range of, but not limited to, 150-200 bar without deteriorating. “Thermally insulating” means the material has a thermal conductivity in the range of, but not limited to, 1.0-20.0 W/m K. According to one embodiment, a material which will satisfy these criteria is a steel alloy containing about 40% nickel and is applied with about 3 mm thickness, with thermal conductivity of 10 W/m K at 200 degrees C. As a comparison, the thermal conductivity of cast A356-T6 aluminum is 130 W/m K at 200 degrees C. with typical thermal gradient distance of 7 mm between combustion chamber and cooling system, and compacted gray iron is 40 W/m K with typical gradient distance of 5 mm. Discrete ceramic components provide insulating performance as low as 2 W/m K, but ceramic requires significant development to be reliably incorporated into the combustion chamber of an internal combustion engine. Powdered metal-ceramic composites and other combustion resistant thermally insulating materials can be used in various embodiments. A discrete ceramic used in the adiabatic engine experiments of the early 1980s is called partially stabilized zirconia (PSZ), refer to SAE Technical Papers 820429 (1982) and 830318 (1983) which are incorporated herein by reference, whose abstracts are currently viewable at www.sae.org/technical/papers, and where the papers may be downloaded. These papers discuss internal combustion engine uses for PSZ.

As indicated, there are thermally insulating materials which insulate better than the selected 40% nickel steel alloy, but these “ideal” insulators may not substantially improve engine thermal efficiency. The selected nickel steel will perform nearly as well as an ideal insulator at high engine RPM, and will only become significantly less efficient than ideal insulators at low engine RPM, when the heat energy of each combustion event has more time to be absorbed by combustion chamber material. Though not as efficient as ceramic at low RPM, the nickel steel combustion chamber 40 retains significantly more thermal efficiency than Otto and Diesel combustion chambers at low RPM. Discrete ceramic insulators may also improve CO exhaust emissions, but turbulence during compression and combustion is expected to heat thermally insulating nickel steel combustion chamber surfaces sufficiently to minimize CO exhaust emissions. According to various embodiments, selective application of commercially available ceramic film coatings to the nickel steel combustion chamber 40 may alternately minimize CO emissions.

According to various embodiments, combustion chamber assembly 10 is constructed such that the cylinder assembly 27 and head assembly 28 are sealed together using a sealing gasket 30 and clamped together with fasteners (not shown). The cast iron cylinder 29 and the head's thermally insulating dish 37 have concentric bores 41A and 41B, together forming a cooperative bore 41C in which the piston assembly 12 reciprocates from a top dead center (TDC) position to a bottom dead center (BDC) position. FIGS. 1 and 2 show the piston assembly 12 at an intermediate position between these limits. Piston assembly 12 connects to a crankshaft (not shown) in a conventional manner by way of a wrist pin 19 and connecting rod 20. The piston assembly 12 has the sealing ring 18 that engages the groove 16 in the outside diameter 15 of the piston assembly 12 and seals at low sliding friction against cooperative bore 41C to prevent leakage of gasses from the combustion chamber 40. The sealing ring 18 is positioned a crevice distance 17A below the compression end 14 such that it slides only against the thermally conductive cast iron portion 41A of the cooperative bore 41C. The concentric bore 41A and sealing ring 18 will be cast of conventional engine construction materials to assure good lubricity and long life at minimum cost. The closed end 25 defines the upper limit of cooperative bore 41C, which resides within the head's insulating dish 37, and which also defines the upper surface of the combustion chamber 40. The combustion chamber's lower surface 42 is defined by the compression end 14 and extends further downward to the sealing ring 18 at the outside diameter 15. The cooperative bore 41C extends between these upper and lower surfaces 25 and 42, and including these upper and lower surfaces, defines the volume of combustion chamber 40. The volume of combustion chamber 40 depends on the position of piston assembly 12 within the cooperative bore 41C. Both the thermally insulating cap 22 and the thermally insulating dish 37 are investment cast of 40% nickel steel, in an embodiment. The thermally insulating cap 22 is inserted into the piston mold and integrally cast with the aluminum piston 21 to become the composite piston 13. Similarly, the dish 37 is inserted into the head mold and integrally cast with the aluminum head 36 to become the composite head 31. The thermally insulating dish 37 will economically integrate the duties of poppet valve seat 38, fuel injector mount 39, and sealing gasket sealing surface. For valve seat wear resistance, there may be some carbon added to the nickel steel thermal insulators to permit localized induction hardening.

According to various embodiments, the poppet valves 33A and 33B installed into this head assembly 28 will be made of an inexpensive stainless steel or nickel steel alloy chosen for comparatively low thermal conductivity and for tribological compatibility with nickel steel poppet valve seats 38. Poppet valves 33A and 33B control the flow of gasses into and from the combustion chamber 40. Sealing surfaces on the stem side of poppet valves 33A and 33B mate with poppet valve seats 38 which are integral to the thermally insulating dish 37 in order to control the flow of gasses between the combustion chamber 40 and ducts 43A and 43B. If poppet valve 33A functions as the intake valve, gasses flow into the combustion chamber 40 through intake duct 43A when intake poppet valve 33A is open. If poppet valve 33A is the intake valve, then poppet valve 33B will function as the exhaust valve. When poppet valve 33B is open, combustion chamber gasses flow from the combustion chamber 40 into an exhaust duct 43B. The pressure within duct 43A should be higher than the pressure in the combustion chamber 40 to cause such flow, and the pressure within duct 43B should be lower than the pressure in the combustion chamber 40 to cause such flow.

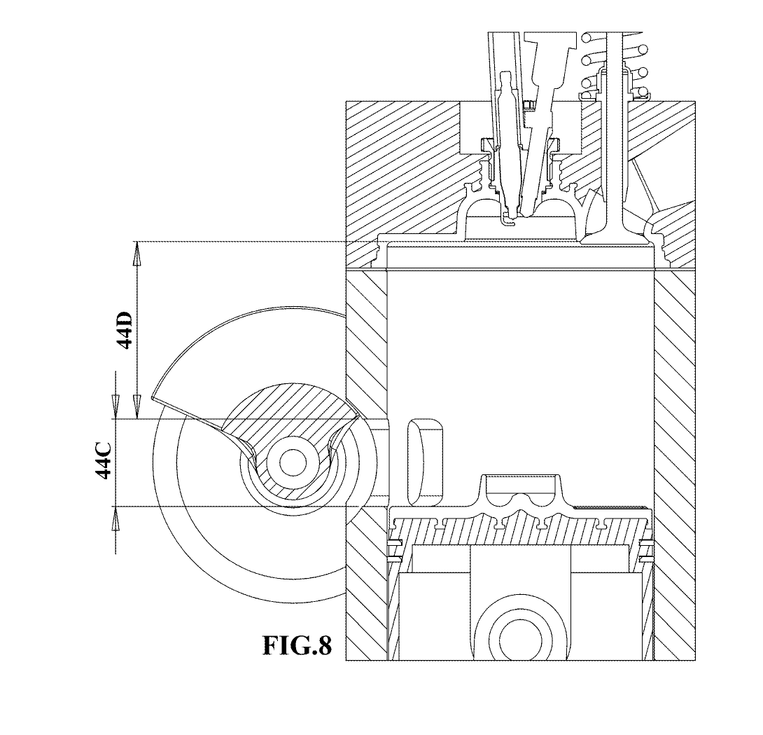

An alternative embodiment to intake poppet valve 33A is an intake port 44A located between the internal bore 23 and external block 26 which has an intake port height 44C (see FIG. 8) and is located an intake port distance 44D from the closed end 25, and multiple ports 44A may be positioned at varying heights 44C and distances 44D in various embodiments. An alternative to exhaust poppet valve 33B is an exhaust port 44B located at the internal bore 23 which is an exhaust port height 44E and exhaust port distance 44F from the closed end 25, and multiple ports 44B may be positioned at varying heights 44E and distances 44F in various embodiments. These ports 44A and 44B flow and become completely restricted depending on the position of the sealing ring 18 in the concentric bore 41A. These ports can become substantially restricted at specific segments of the engine cycle by a rotary drum valve assembly 45 at the external block 26 which rotates and restricts flow. When in a closed position, the rotary drum valve assembly 45 provides substantial flow resistance to combustion chamber gasses while also generating minimal mechanical friction to the external block 26 due to close clearance gaps between the rotary drum valve assembly 46 and the external block 26. A direct injector 34 momentarily provides fuel during a segment of the compression cycle prior to the start of combustion. Combustion will initiate at or before TDC using either a spark plug 35 or compression ignition. The piston's compression end 14 has on it a thermally insulating cap 22 extending to the outside diameter 15 and then downward toward the sealing ring 18. The head assembly 28 has, on the cooperative bore 41C and on the cylinder's closed end 25, a thermally insulating dish 37 extending outward to the cooperative bore 41C and then extending downward toward the sealing ring 18 when at TDC. The distance the insulation travels down the cylinder bore 41C, if any, is called the “insulated dish distance” 46A (see FIG. 4), and defines the length of the thermally insulating portion 41B of cooperative bore 41C.

The combustion chamber 40 predominantly insulates when the piston's compression end 14 is positioned within an insulation distance 46A of the cylinder's closed end 25, in an embodiment. The combustion chamber 40 partially insulates when the piston's compression end 14 is positioned greater than an insulation distance 46A from the cylinder's closed end 25, such that the thermally conductive cylinder bore 41A is directly exposed to combustion chamber gasses. FIG. 4 shows the combustion chamber 40 when the piston assembly 12 is located at the threshold position between partially insulating and predominantly insulating. The thermally insulating segments of the combustion chamber 40 exist to reduce heat energy conduction into the cooling system, thereby retaining heat energy to perform mechanical work. The thermally conductive segments of the combustion chamber 40 exist to circumvent the tribological development requirements associated with thermally insulating materials.

The clearance between the outside diameter 15 and cooperative bore 41C, in conjunction with a crevice distance 17A from the sealing ring 18, defines a thin cylindrically shaped crevice volume 47 containing both fuel and air in engines which port induct fuel or in engines which direct inject fuel distinctly prior to ignition, yet crevice volume 47 is not shaped to support efficient combustion. Similar combustion chamber volumes which do not efficiently support combustion include the fitment crevice surrounding the sealing gasket 30 and the perimeter junction between the intake poppet valve 33A and the poppet valve seat 38. If fuel was present, these crevice volumes would generate HC combustion pollutants which must be controlled using a catalytic converter, but the operating mode of this combustion chamber generates unconventionally cool exhaust temperature which renders catalytic converters inoperative. An alternative construction which prevents fuel from entering these crevices is needed. A conventional alternative would be to compression-ignite direct-injected fuel beginning near TDC, like a Diesel engine, in order to assure only pure air resides in the crevice volume 47. This direct injection application eliminates crevice-sourced HC emissions, but generates soot emissions, since a diesel engine has intrinsically sooty exhaust gasses because spontaneously combusted fuel injected at TDC is directed into the center of a flame kernel that has already consumed most nearby oxygen. Diesel engines require particulate burners in their exhaust system to remove soot pollutants, however particulate burners require conventionally hot exhaust gasses to perform effectively. The operating mode of this IPC engine's combustion chamber 40 generates unconventionally cool exhaust gasses, rendering the Diesel engine's particulate burner inoperative.

An effective solution to this combustion pollution issue is to employ combustion chamber stratification, in conjunction with the specialized timing of direct injected fuel, to prevent soot emissions while keeping fuel out of combustion chamber locations which don't support efficient combustion. The thermally insulated combustion chamber 40 is transitions from unstratified to stratified each time the compression end 14 travels from BDC toward TDC and reaches a stratified distance 48A from the closed end 25. The combustion chamber 40 transitions from stratified to unstratified each time the compression end 14 travels from TDC toward BDC and reaches the stratified distance 48A from the closed end 25. The combustion chamber 40, when stratified, includes a central combustion region 49B which is optimized to support efficient combustion, a perimeter squish region 49D which actively rejects admission of direct injected fuel, and an annular transfer passage 49C which communicates between the regions, where the sum of the volumes of these regions and passage equals the volume of the combustion chamber 40. The combustion chamber 40, when unstratified, includes a single region 49A, where the volume of the single region 52 equals the volume of the combustion chamber 40. The stratified distance 48A is selected to initiate stratification distinctly prior to the start of direct fuel injection. The stratified distance 48A is independent of the insulation distance 46A. The perimeter squish region 49D is shaped to keep direct injected fuel away from combustion chamber features which do not efficiently support combustion. While the piston assembly 12 is rising and the combustion chamber 40 is stratified, the perimeter squish region 49D also acts as an air reservoir which expels air toward the central combustion region 49B to turbulently mix direct injected fuel with inducted air prior to ignition. A direct fuel injector 34, positioned to inject fuel only into the central combustion region 49B of the combustion chamber 40, begins injecting fuel during a segment of the compression cycle distinctly after stratification initiates, and there exists a turbulent fuel-air mixing period between the end of direct fuel injection and the instant of ignition. The direct injector nozzles are aimed to inject fuel mass into the piston pocket 50 at the center of the central combustion region 49B. The air pumping action from the perimeter squish region 49D actively constrains direct injected fuel to the central combustion region 49B. When at TDC the central combustion region 49B is shaped to fully support combustion: The central combustion region 49B is shaped to generate within its confines a toroidal vortex as air is pumped in from the perimeter squish region 49D, assuring all fuel is in motion to uniformly mix and combust. Though the general shape of the central combustion region 49B at TDC is shown as toroidal, other general shapes, such as spherical or cylindrical, will also promote a toroidal vortex, providing both efficient fuel-air mixing and efficient combustion.

The thermally insulated chamber surface absorbs minimal heat energy, and therefore it heats up quickly during compression and combustion to assure fuel located in close proximity to the thermally insulated material combusts completely and cleanly. The surface area per unit volume of the central combustion region 49B is low, when compared to the entire combustion chamber 40 at TDC, to promote an efficient combustion reaction. At TDC, the annular transfer passage 49C acts to buffer the combustion reaction. As the combusting reaction heats up after ignition, pressure builds and the reaction expands beyond the central combustion region 49B. At TDC the combusting gasses efficiently spill into a nearby segment of the annular transfer passage 49C which is shaped to fully support combustion. This spillover causes pure air to be pushed out of the annular transfer passage 49C into the perimeter squish region 49D. This action causes air pressure to adiabatically build in the perimeter squish region 49D, and the inducted air presses back to constrain the expanding combustion reaction to the upper segment of the annular transfer passage 49C. The shape and volume of the annular transfer passage 49C at TDC assures combusting gasses will not undesirably spill into the perimeter squish region 49D.

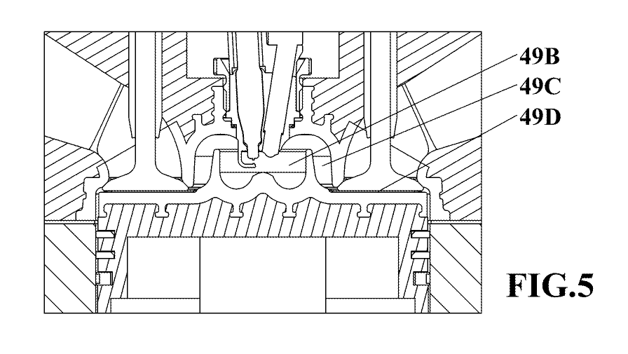

The central combustion region 49B may be constructed to optimally combust at a high heat release rate near TDC, as shown in FIG. 5, and transfer fully combusted gasses back into the perimeter squish region 49D as the piston assembly 12 moves away from TDC, or it may be constructed to optimally combust at a conventional low heat release rate, continuing the combustion reaction throughout the annular transfer passage 49C to complete the combustion reaction in regions of the perimeter squish region 49D which support efficient combustion. The combustion chamber 40, when stratified, may be constructed to regularly switch between combusting at a high heat release rate and combusting at a low heat release rate, depending on operating requirements at a given moment. The stratified combustion chamber 40 described above was created to resolve pollution issues within the described thermally insulated environment, but the described combustion chamber 40 is also functional in applications which employ reduced thermal insulation or no thermal insulation, and therefore require a conventional cooling system in various embodiments. Such secondary operating modes may port induct a fuel-lean charge to supplement the direct injected charge, in order to operate momentarily at higher volumetric efficiencies and lower thermal efficiencies. A single intake poppet valve 33A and single exhaust poppet valve 33B is shown, but multiple poppet valves 33A and 33B may be beneficial, since the shape of the stratified combustion chamber may limit the valve head diameter such that it restricts thermal efficiency and volumetric efficiency. Variable valve timing and variable valve duration can improve both thermal efficiency and volumetric efficiency, but at additional engine cost and complexity. Additionally, variable valve timing at individual cylinders and variable duration at individual cylinders can efficiently support cylinder deactivation, keeping a combustion chamber operating within a more thermally efficient range, though again, at increased engine cost and complexity.

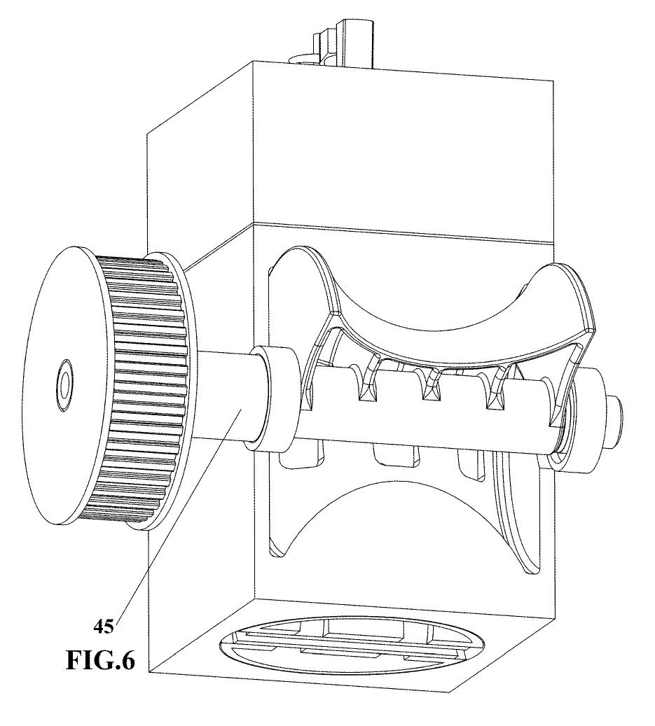

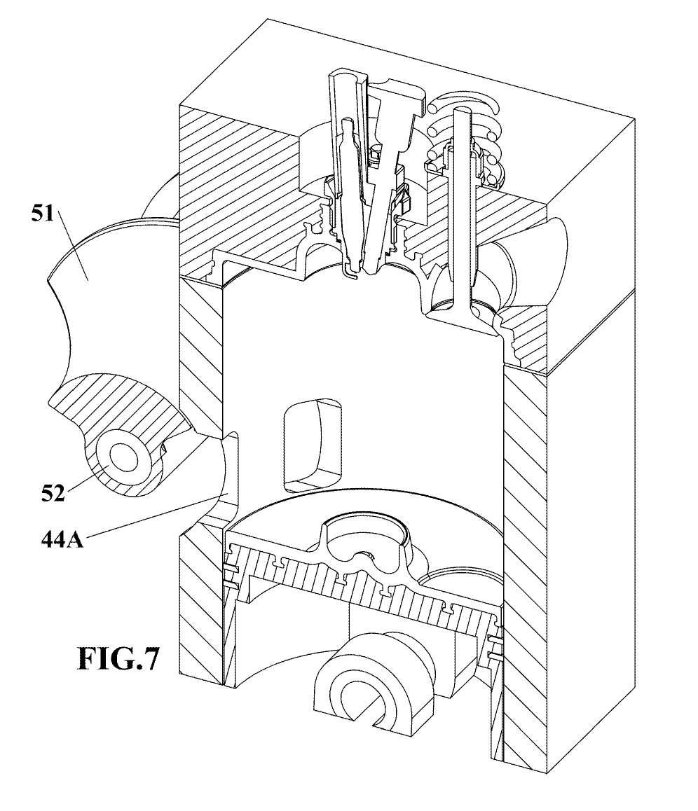

FIG. 6 shows a rotary drum valve assembly 45. FIG. 7 shows a rotating drum 51 and a drum axle tube 53 at the external block 26. This rotary drum valve assembly 45 is being used to control the flow of gasses into the combustion chamber 40. The rotary drum valve assembly 45 is machined with a small clearance between the rotating drum 51 and external block 26 to prevent friction and wear, while providing substantial air flow resistance during specific moments of the engine operating cycle. This construction allows inducted air to contact only externally visible surfaces of the rotary drum valve, and is shaped to generate a controlled volume of slightly elevated air pressure just before the drum rotates to obstruct the intake port. An intake manifold (not shown) surrounds this rotary drum valve assembly to permit filtering of ambient air, to control acoustic noise, and to control turbulence. An alternate construction of the rotating drum 51 contain a perforation (not shown) which directs gasses to flow into, and from, the rotating drum's interior volume. Alternate constructions of the drum axle tube 52 are sized to permit low restriction internal flow of gasses between the perforation in the rotating drum 51 and an end of the drum axle tube 52.

### Insulated Pulse Engine

One application for the disclosed stratified combustion chamber is an internal combustion engine concept named the “insulated pulse engine”. The insulated pulse engine explores adiabatic engines, though it is not like published adiabatic engines which expel superheated combustion gasses into an exhaust duct for the post-processing of energy. The insulated pulse engine is a “cold adiabatic engine” which allows combusted gasses to adiabatically expand and cool before exiting the combustion chamber.

The “insulated pulse-combustion engine”, abbreviated “insulated pulse engine” or “IPC engine”, is a low volumetric efficiency internal combustion engine concept which combusts fuel at high thermal efficiency. The combustion chamber is selectively insulated to minimize heat energy loss to a cooling system. Combustion initiates and is consumed rapidly near top dead center (TDC), permitting adiabatic cooling of combustion chamber gasses through the entire expansion stroke. The expansion stroke is extended beyond convention to extract additional heat energy from the combusted gasses, further reducing average combustion chamber temperatures to minimize stress on the thermal insulators, resulting in an exhaust that is comparatively cool and pressureless. Conventional emissions control devices won't work with low temperature oxygen-rich exhaust gasses, so the IPC engine stratifies the combustion chamber to locally combust in a region of the combustion chamber specifically shaped to support efficient, clean combustion. Stratification additionally permits selection of an optimal fuel-air equivalence ratio range of 0.38-0.75 to assure a rapid, complete combustion reaction. A fuel-air equivalence ratio other than 1.00 represents the deviation from a stoichiometric ratio. Stoichiometric fuel-air, as typically found in Otto and Diesel engines at full throttle, has a 1.00 equivalence ratio.

In one embodiment, an IPC engine application is a 50 horsepower 3.2 liter in-line 4-cylinder engine coupled to a 6-forward speed automatic transmission in an electric hybrid automobile which employs an electrically interfaced 80 horsepower 500 kJ carbon filament flywheel module weighing 25 kg to store traction energy. Three primary constructions include: 4-stroke valve-in-head, 2-stroke exhaust valve in head, and 2-stroke cylinder port only. The cylinder bore diameter of the 3.2 liter IPC engine is 100 mm and the piston stroke is 100 mm. Each of these engine constructions has a 4000 RPM redline defined by the combustion reaction velocity of the selected fuel. Each engine combusts cleanly with minimal need for emissions controls. When compared with Otto and Diesel engines at full throttle, a similarly displaced IPC engine at full throttle consumes roughly an eighth of the fuel each combustion event. This is based on the observation that HCCI prototype engines at full throttle consume a fourth the quantity of fuel as an Otto or Diesel engine of similar displacement at full throttle, and only half the stroke of the IPC engine is used during the compression cycle. The IPC engine is expected to have twice the fuel efficiency of Otto and Diesel engines, and will therefore generate roughly a fourth of the horsepower of similarly displaced Otto and Diesel engines at full throttle and similar RPM. The cylinder displacement requirements of an IPC engine are roughly four times that of Otto and Diesel engines at equivalent horsepower and RPM, but the cost, weight, and space requirements of the IPC engine assembly remain comparable due to a reduction in need for cooling, muffling, and emissions control components. Since mechanical friction is a variable which correlates more closely to generated horsepower than to displacement, and since the IPC engine is constructed using methods which emphasize reduction of mechanical friction and windage friction, friction generated within the IPC engine is comparable to friction generated within equivalently powered Otto and Diesel engines.

### Cooling System Losses

Internal combustion engines incorporate a cooling system to quickly remove heat energy absorbed by combustion chamber metals after each combustion event. This removal is necessary, since chamber metals would otherwise attain the average temperature of the combustion chamber gasses, a temperature too hot in Otto and Diesel engines for sustainable engine operation. Heat energy conducted through the combustion chamber metal into the cooling system represents a significant reduction in the thermal efficiency of an engine. Following the oil crisis of 1979, internal combustion engine manufacturers around the world began developing “adiabatic engine” prototypes which contained thermally insulated ceramic combustion chambers in an attempt to improve engine thermal efficiency without sacrificing volumetric efficiency. Thermally insulating the combustion chamber reduced, and sometimes eliminated, the need for a cooling system, thus retaining a larger fraction of combustion heat energy for mechanical work output. These adiabatic engines were designed to combust with a conventional low heat release rate. This low heat release rate superheated the combustion chamber gasses before expelling them into the exhaust duct for the purpose of energy recovery through turbocompounding and other post-processing methods.

Experimental results on three of the published adiabatic engine projects can be reviewed in SAE technical papers 810070 (1981), 820431 (1982), and 840428 (1984), which are incorporated by reference, with abstracts viewable at www.sae.org/technical/papers, and where the papers may be downloaded. Adiabatic engines of the 1980s operated under the most brutal conditions. Adiabatic engines provided improved fuel efficiency, but could not be made sufficiently reliable for commercial application. The use of a ceramic material, or the use of any thermally insulating material, to insulate combustion chambers of internal combustion engines for the primary purpose of improving fuel mileage in vehicles has found minimal research interest in the industry since the conclusion of these experiments.

### Exhaust System Efficiency Losses

In both Otto and Diesel engines, and in the adiabatic engine experiments described above, combustion is engineered to progress gradually, beginning near TDC and continuing well into the expansion cycle. This low heat release rate allows a lot of fuel to gradually burn without exceeding the pressure limits of the combustion chamber, providing high volumetric efficiency and low thermal efficiency. Volumetric efficiency is high because the piston experiences high levels of combustion pressure through a significant portion of the expansion stroke. Thermal efficiency is low because the late burning fuel cannot adiabatically expand as many times as the early burning fuel. This late burn causes large amounts of fuel energy to be lost to the exhaust in the form of heat and pressure. Unfortunately, the large volume of fuel Otto and Diesel engines require to generate high levels of horsepower cannot all be combusted at TDC without exceeding the pressure limits of the combustion chamber, so the Otto and Diesel engines reduced burn rate is necessary to achieve high volumetric efficiency. As applied in the adiabatic engine experiments of the 1980s, this longer burn duration exposed ceramic combustion chamber surfaces to more heat energy, raising temperature gradients within the body of the ceramic. The lower heat release rate may have set up thermal gradient stresses within the ceramic which contributed to reduced ceramic durability. By contrast, HCCI engine prototypes in research laboratories today combust all fuel near TDC and none during the expansion cycle, and Atkinson engines extend the expansion stroke until useable combustion pressure is mechanically consumed. These latter two engines release less heat energy to the exhaust than do equivalently powered Otto, Diesel, and adiabatic engines.

### Thermal Efficiency in an Internal Combustion Engine

Thermal efficiency in an internal combustion engine is comprised of three core efficiencies: 1) insulation efficiency; 2) combustion efficiency; and 3) friction efficiency. Insulation efficiency reduces the loss of combustion energy to a cooling system in the form of heat. High insulation efficiency is one of two basic elements found a true adiabatic engine. Combustion efficiency reduces the loss of combustion energy to the exhaust duct in the form of heat and pressure. High combustion efficiency is the second of two basic elements found in a true adiabatic engine. Friction efficiency reduces combustion energy loss to mechanical friction and to air pumping within the engine.

Insulation efficiency was incorporated into the adiabatic engine experiments of the early 1980s, but combustion efficiency was not. These “adiabatic engines” were, in effect, half-adiabatic, not fully adiabatic. These experiments retained a low heat release rate which generated significant heat energy loss to the exhaust cycle. Only the fuel burning near TDC combusted at high adiabatic efficiency. The bulk of the fuel combusted after TDC had passed, and it combusted at reduced adiabatic efficiency. The result was a brutally hot combustion and exhaust process which provided some improvement in thermal efficiency over Otto and Diesel engines, but did not allow sufficient reliability for commercial applicability. PSZ ceramic was not sufficiently durable in the adiabatic engine experiments to become commercially applicable, though it performed remarkably well considering the severity of testing. It is expected PSZ will perform quite reliably at the lower average combustion chamber temperatures and milder thermal gradients within the IPC engine, but it must be incorporated in a manner which applies minimal tensile loading, preferring compressive loading where loads must exist.

Insulation efficiency is not incorporated into HCCI engines. Combustion efficiency is, in part, incorporated into the HCCI prototype engines being researched around the world today. Combustion is efficient, in that the entire combustion reaction occurs at a “high heat release rate” near TDC, but the expansion stroke is not extended, losing useable heat energy and pressure to the exhaust before it can perform work. The HCCI engine is effectively “quarter-adiabatic”. Insulation efficiency is not incorporated into Atkinson engines. Combustion efficiency is, in part, incorporated into Atkinson engines being produced today. While combustion proceeds at a thermally inefficient “low heat release rate” in the Atkinson engine, the expansion cycle is extended in stroke length beyond that of the compression cycle, and this allows extraction of additional energy from the combustion process. This also defines the Atkinson engine as “quarter-adiabatic”.

Insulation efficiency and combustion efficiency are both fully incorporated into the IPC engine, and the constructions described herein will provide a notable increase in fuel efficiency over adiabatic, HCCI, and Atkinson engines while combusting cleanly, without need for pollution controls. The IPC engine is a true adiabatic engine construction, but to prevent confusion with established naming practice, the IPC engine is probably best called a “cold adiabatic engine”, since it transmits minimal heat to a cooling system and expels minimal heat energy into the exhaust duct.

### Exhaust Emissions

Exhaust emission concerns in the insulated pulse engine fall into four simplified categories: 1) hydrocarbon (HC) exhaust emissions; 2) soot emissions; 3) carbon monoxide (CO) emissions; and 4) oxides of nitrogen (NOx) emissions. HC exhaust emissions, representing fuel that is not combusted, are formed when fuel is in proximity of chilled combustion chamber crevices such as are found near the head gasket, upper piston ring, and intake valve seat. Soot emissions, also known as particulate matter (PM) emissions, representing fuel that is ⅓ combusted, are formed when fuel is direct injected into the dense flame kernel of a compression ignition engine which has already consumed all adjacent oxygen. CO emissions, representing fuel that is ⅔ combusted, are formed when fuel is combusted near chilled surfaces within the combustion chamber. NOx emissions are generated when heat energy becomes unnecessarily high in the combustion chamber and the very stable 3-bond nitrogen molecule breaks apart. The cause of exhaust pollution in internal combustion engines is complex but well understood, as are clean combustion methods which prevent pollution, and as are exhaust processing methods which remove pollution.

Constructions which promote clean combustion have been extensively adopted by the IPC engine, since the cool temperature of the IPC engine's exhaust renders many popular emissions control devices ineffective, as many depend on significant levels of exhaust heat to function. Combustion in the IPC engine is sufficiently unique that some form of emissions control will likely be required, but emissions levels should be sufficiently low that incorporation of the needed controls will not significantly affect cost or thermal efficiency.

### Insulated Pulse Engine Embodiments

The insulated pulse engine is an ordinary reciprocating piston internal combustion engine which applies unthrottled air induction, direct fuel injection, spark ignition, and the following three unconventional functions to achieve high thermal efficiency: 1) Rapid “pulse” combustion (like an HCCI engine); 2) Thermally insulated combustion chamber (like an adiabatic engine); 3) Extended expansion cycle (like Atkinson engine). These three unconventional functions combine to create an engine with both high thermal efficiency and low volumetric efficiency. Mechanical friction and windage friction take on greater significance in engines with reduced volumetric efficiency. The insulated pulse engine must consider reducing friction to levels below that of conventional engines. This lists a few methods which may cost-effectively reduce friction: 1) Twin counter-rotating crankshafts eliminate piston side thrust friction; 2) With a single crankshaft, a longer connecting rod reduces piston side thrust friction; 3) Reducing excessive piston skirt contact area reduces viscous friction; 4) Gas ported low-tension piston rings reduce piston sliding friction; 5) Minimize port flow volume and resistance, avoid throttled induction; 6) Minimize crankcase windage with vacuum and strategic bulkhead vents; 7) Turbulence should mix fuel with air efficiently, not excessively; 8) Rolling contact bearings, where possible, consume less energy than friction bearings. The resulting engine requires only an active oil cooler of ordinary capacity to support all cooling needs, does not require a muffler to function quietly, and exhaust gasses can be made sufficiently cool that the exhaust manifold can be molded of plastic. Friction reduction will improve thermal efficiency, according to various embodiments.

### Rapid “Pulse” Combustion

In an IPC engine, combustion initiates near TDC and is rapidly consumed near TDC, providing combustion with low volumetric efficiency and high thermal efficiency. The volumetric efficiency is low because a comparatively small amount of fuel will generate sufficient temperature and pressure near TDC to reach the limits which do not form NOx exhaust pollutants. Thermal efficiency is high because all of the combusted gasses adiabatically cool through the entire expansion stroke, greatly reducing the percentage of heat energy lost out the exhaust and lowering the average temperature of the combustion chamber. The ordinary methods selected to achieve this high heat release rate are: 1) High compression ratio; 2) Combustion chamber shaped to fully support efficient combustion; 3) Fuel-air charge turbulently mixed prior to ignition; 4) Combustion chamber turbulence present at time of ignition; 5) Additional combustion chamber turbulence generated by combustion reaction; and 6) Fuel-lean equivalence ratio optimized for rapid, complete reaction.

Complete combustion at TDC in the IPC engine does not generate destructive pressure, as there is an insufficient quantity of fuel in the combustion chamber during each combustion event to generate excessive pressure. Pressure and temperature limits in the IPC engine's combustion chamber are not driven by structural limits, but are driven by the need to prevent the formation of NOx emissions during combustion. If temperature and pressure in the combustion chamber climb sufficiently high that the very stable 3-bond nitrogen molecule breaks apart and forms NOx emissions, then temperature and pressure must be readjusted below NOx-producing levels, since the IPC engine is intended to combust cleanly without pollution controls. Engine misfire may occasionally cause an anomalous stoichiometric fuel-air mixture to combust at detonation pressures in the chamber. The IPC engine, like conventional engines, is constructed to handle this type of misfire condition.

### Thermally Insulated Combustion Chamber

The IPC engine thermally insulates the combustion chamber completely when the piston is within 9 mm of TDC, and partly insulates when the piston is further than 9 mm from TDC. Three reasons for insulating are to 1) increase thermal efficiency by minimizing heat energy loss to the cooling system during the hottest portion of the compression and expansion cycles; 2) to burn cleanly at TDC by assuring critical combustion chamber surfaces reach higher temperatures during compression and combustion to prevent the formation of CO exhaust emissions; and 3) to bring the combustion chamber up to operating temperature as fast as possible after a cold start to minimize HC and CO exhaust pollutants.

### Extended Expansion Cycle

The IPC engine incorporates an extended expansion cycle, much like an Atkinson engine, to let combustion energy perform additional motive work before discharge to the exhaust. The extended expansion stroke further reduces average combustion chamber temperature, bringing the average combustion chamber temperature down to the level where a cooling system is not required at all, except perhaps when running at full throttle in hot ambient conditions. When cooling is required, excess heat is readily removed via an external oil cooling system of ordinary capacity. An expansion ratio value is selected which will assure expansion energy gains constructively exceed friction force losses through the entire expansion stroke, though fuel prices may apply market-driven pressure to the final specification of the expansion ratio. The conventional internal combustion engine has evolved to assume the compression and expansion cycles should be matched in stroke length. The compression stroke and the expansion stroke are each driven by significantly different physical parameters and mathematical equations, and their lengths will seldom coincide if maximized thermal efficiency is a primary goal. In the IPC engine, the compression stroke is about half the distance of the expansion stroke.

### Stratified Combustion Chamber

Two issues exist with the combustion process described for the IPC engine: First, combusting at TDC with a homogenous mix of fuel and air shows that the fuel-lean equivalence ratio should be no more than about 0.25 to prevent excessive cylinder pressure, but equivalence ratios in this low range generate an incomplete combustion reaction which creates CO exhaust pollutants, as demonstrated in HCCI engine prototypes. Second, with homogenously mixed combustion reactions, there exist locations in the combustion chamber which don't support efficient combustion, yet which contain fuel and air. Examples of these locations include the clearance between the piston and cylinder bore above the sealing rings, the surface of the head gasket exposed to the combustion chamber, and the junction adjacent to the intake valve and seat. HC pollution is created in these locations of a homogenously inducted combustion chamber.

A stratified combustion chamber can resolve both of these issues. By splitting the combustion chamber into two compartments just prior to fuel injection, one region can be designed to contain only air, while the other region contain both fuel and air, permitting clean and fast combusting fuel-air equivalence ratios closer to 0.38-0.75 while segregating features which don't support combustion into the air-only region of the combustion chamber. The fuel-air region can be optimally shaped to fully support combustion, and a transfer passage between the two regions can be designed to support efficient expansion of the combustion reaction. The stratified combustion chamber for the IPC engine forms when the piston is within 12 mm of TDC and is shaped for clean fast combustion only when the piston is within 0.5 mm of TDC. Spark ignition is required to assure combustion occurs precisely within this positional constraint. The rate of the combustion reaction is driven, in part, by the selected fuel, the compression ratio, the fuel-air equivalence ratio, chamber turbulence, and engine RPM, and will require a specified length of time to burn completely and cleanly. This reaction time defines an engine RPM maximum which, if exceeded, will result in pollution emissions. The IPC engine operates with greatest thermal efficiency at or just below this RPM maximum. A maximum RPM value of 4000 has arbitrarily been assigned to the IPC engine for instructional purposes. Thermal efficiency of the 40% nickel steel alloy drops at low RPM, but the nickel steel combustion chamber will operate at low RPM with far greater thermal efficiency than can conventional engines, and nickel steel is presently seen as more reliable than a ceramic combustion chamber.

### Insulated Combustion Chamber

The IPC engine includes a thermally insulated combustion chamber, in various embodiments. The piston assembly contains an insulating cap, and the head assembly contains an insulating dish. The unique size and shape of the stratified combustion chamber results in a reduction in the valve head diameter, having a multi-valve arrangement to retain low-restriction intake and exhaust flow. These two insulating components will be investment cast out of a nickel steel alloy chosen for low thermal conductivity, high temperature stability, and valve seat wear resistance. For valve seat wear resistance, there is some carbon added to permit localized induction hardening in various embodiments. In an embodiment, one of these insulators is inserted into the die cast mold of an aluminum piston to keep reciprocating mass low, the other is inserted into the mold of a cast aluminum cylinder head to keep engine mass low. The head insulator combines the duties of valve seat, spark/injector mount, and head gasket sealing surface. The valves installed into this head assembly are made of an inexpensive stainless steel or nickel steel alloy chosen for comparatively low thermal conductivity and for tribological compatibility with the nickel steel valve seats, in various embodiments. In various embodiments, the cylinder bore and piston rings are cast of conventional engine materials to assure good lubricity and long life at minimal cost. Because the cylinder is made of conventional materials which are thermally conductive, the combustion chamber will only be fully insulating when the piston is within 9 mm of TDC. With the brief combustion reaction near TDC, combustion chamber temperatures drop considerably by the time the cast iron cylinder bore is significantly exposed to combustion chamber gasses, minimizing heat energy loss. The combustion chamber predominantly insulates when the piston is within 9 mm of TDC. The combustion chamber partially insulates when the piston is farther than 9 mm from TDC. As the piston travels from TDC toward BDC, and while the piston remains closer than 9 mm to TDC, the heat generated by the combustion reaction is almost entirely dedicated to applying force to the crankshaft, finding minimal opportunity to route heat energy to the cooling system. The combustion chamber switches from predominantly insulating to partially insulating when the piston drops below 9 mm from TDC, as a segment of thermally conductive cast iron cylinder bore starts to occupy a small portion of the combustion chamber's surface area. Combustion chamber gasses have adiabatically dropped in temperature by the time the thermally conductive cylinder bore surface becomes a significant percentage of the combustion chamber surface area, greatly reducing heat energy absorption into the cast iron cylinder. The thermally insulating segments of the combustion chamber exist to reduce heat energy absorption, thereby preserving heat energy for mechanical work, and to assist with complete combustion to minimize pollutant emissions. The thermally conductive segments of the combustion chamber exist in order to circumvent the significant tribological development requirements associated with using thermally insulating materials as wear surfaces.

### Oil Cooling

Since the thermally conductive cast iron cylinder bore cyclically forms a portion of the combustion chamber, it absorbs a small portion of the heat of combustion. The average cyclic temperature of the cast iron cylinder bore remains below that which requires active cooling. The thermally insulating portion of the combustion chamber slowly absorbs some of the heat of combustion and needs to transfer this heat away. The cooling method is managed by ordinary oil circulation within the engine. The oil circulation system assures all parts of the engine are lubricated as required, and all are kept at functional temperatures. Should the oil temperature climb to a designated upper limit, an external oil cooling circuit activate, in various embodiments. This external cooling circuit includes a small radiator and blower fan, in various embodiments. When wind and cold weather are present, the IPC engine is suited to operate in an enclosure without ambient venting, to prevent engine overcooling. Since the IPC engine can be operated in conditions where the oil temperature remains cool for extended periods (cold climates, short trips), the oil may become saturated with water and degrade. An oil heat exchanger can be incorporated adjacent to an exhaust duct, and exhaust gasses can temporarily be routed through the oil heat exchanger whenever oil is below a specified minimum operating temperature, in various embodiments. Since reactive combustion energy does not contact the cylinder bore in an IPC engine, cylinder bore oiling requirements are not as severe as those in conventional engines in which a flame contacts the internal bore. The 2-stroke piston has the oil control ring positioned low on the piston skirt, and as long as the oil ring's travel path overlaps that of the compression rings there is sufficient lubrication.

### Stratified Combustion Chamber Properties

The uniquely shaped combustion chamber of the IPC engine forms a small but significant volume between the piston and cylinder bore above the compression sealing rings. This small cylindrical volume is not shaped to support efficient combustion, and will generate pollution emissions if fuel is allowed to occupy this volume. Similar inefficient volumes in the combustion chamber exist at the head gasket and valve seats. Modern Otto cycle engines design the pistons to minimize these inefficient volumes, and the few exhaust emissions forming in the small volumes are scrubbed clean by a catalytic converter. Minimizing this volume in an IPC engine uses a reduction of thermal insulation coverage, in order that the sealing rings can be located as close as possible to the compression end of the piston. This may reduce thermal efficiency of the engines. Additionally, the IPC engine generates a comparatively cool exhaust when compared with an Otto engine, and conventional catalytic converters do not perform efficiently at these lower exhaust temperatures. For this reason, the IPC engine takes another approach to eliminating crevice-sourced pollutant. The IPC engine minimizes pollution created in areas of the combustion chamber which don't support efficient combustion, since it is designed to keep direct injected fuel out of these locations. The established way to keep fuel away from these locations is to operate as a Diesel cycle engine, spontaneously combusting direct injected fuel as it enters the combustion chamber, but Diesel engines intrinsically suffer from soot emissions, since fuel must be injected directly into the center of a dense flame kernel which has already consumed all adjacent oxygen. Diesel engines must remove soot pollution from the exhaust using a particulate burner, but a particulate burner does not function efficiently with the comparatively cool exhaust of the IPC engine. As stated above, a solution for the IPC engine is found in combustion chamber stratification. Combustion chamber stratification, in coordination with an insulated combustion chamber, pulse combustion, uniquely timed direct injection, and spark ignition, combine to create a combustion environment which favors clean combustion and minimizes the generation of exhaust pollutants, minimizing the need for emissions controls.

According to an embodiment, the combustion chamber of the IPC engine is stratified only when the piston is located within 12 mm of TDC. When the piston is farther than 12 mm from TDC there exists only one region in the chamber. The stratified combustion chamber forms when the piston is at 12 mm BTC, segregating into a perimeter squish region which actively rejects fuel and a central combustion region which is optimized mix injected fuel with air and combust cleanly. An annular transfer passage communicates between the two regions, transferring air toward the central combustion region as the piston rises above 12 mm BTC, returning fully combusted gasses to the perimeter squish region as the piston falls to 12 mm ATC. The annular transfer passage also provides a buffer at TDC which efficiently constrains the combustion reaction. The perimeter squish region assists complete combustion: it keeps fuel away from combustion chamber features which do not efficiently support combustion. While the piston approaches TDC the perimeter squish region acts as an air pump which transfers air toward the central combustion region to turbulently mix injected fuel with air prior to ignition. Direct fuel injection begins when the piston is 8 mm BTC and ends by 6 mm BTC in an embodiment. The direct injector nozzles are aimed to inject fuel mass only into the piston pocket at the center of the central combustion region. In various embodiments, the air pumping action actively constrains all direct injected fuel to the central combustion region, permitting selection of fuel-air equivalence ratios in the range of 0.38 to 0.75 which combust most rapidly and cleanly, rather than the pollution-prone 0.13 to 0.25 equivalence ratio range which would occupy a homogenous IPC engine's combustion chamber. Note that the volume of the perimeter squish region approaches zero at TDC, whereas the volume of the central combustion region approaches a finite value at TDC, creating an effective air pump directed from the perimeter squish region toward the central combustion region in the last 12 mm before TDC, in an embodiment. The central combustion region is shaped to support combustion: the surface area of the central combustion region is comparatively low to assist a speedy combustion reaction. The insulated chamber surface heats up quickly during compression and combustion to assure fuel in close proximity to the insulated material combusts properly. The central combustion region is shaped to generate within itself a toroidal vortex as air is pumped in from the perimeter squish region, assuring all fuel is in motion to uniformly combust, the turbulence minimizing both cold and hot spots in the central combustion region which helps prevent pre-ignition.

The annular transfer passage acts to buffer combustion at TDC. As the combusting reaction heats up at TDC, it expands beyond the central combustion region. The combusting gasses efficiently spill into a segment of the annular transfer passage which fully supports combustion, while pure air residing in the annular transfer passage is pushed into the perimeter squish region. Only when the piston falls 0.5 mm after TDC do combusted gasses significantly occupy the annular transfer passage and approach the perimeter squish region, and by this time the combustion reaction has completed. Any residual fuel that is not completely combusted when the piston falls to 0.5 mm ATC will exit the combustion chamber as a pollutant. In the one embodiment, there is not a second opportunity to combust fuel that does not combust near TDC. Creviced features, such as valve seats and spark plug insulation recesses are not permissible in the combustion area, if exhaust emissions are to be low. According to an embodiment, the central combustion region at TDC is sized to be half the volume of the crevice chamber plus the backfill passage at TDC, allowing a full throttle fuel-air equivalence ratio of 0.75.

### Compression Ratio and Expansion Ratio

The IPC engine inducts unthrottled air, much like a Diesel engine. The IPC engine adiabatically pre-warms the induction charge during compression to just below the auto-ignition temperature of the fuel-air mixture, promoting rapid combustion when a spark is generated near TDC. This puts the dynamic compression ratio (DCR) at approximately 15:1. In flex-fuel configurations, the compression ratio is actively regulated to assure compression pressure remains just below the autoignition level as conditions change. This is accomplished by monitoring ignition reactivity and continuously serving valve closure timing to suit. In one embodiment, the dynamic expansion ratio (DER) will be about 30:1 to minimize heat energy loss to the exhaust duct, much the way an Atkinson engine minimizes exhaust energy loss. The selection of 30:1 for the DER is based on the assumption that a peak combustion chamber pressure of 150 bar at TDC will not form oxides of nitrogen pollutants, and on the prevalence of predominantly diatomic gasses of the fuel-lean combusted charge obeying, to a first order approximation, the 150 bar/(30̂1.4)=1.3 bar equation. Mechanical friction drives a deviation from the 1.3 bar specification at BDC, though fuel prices may additionally influence the selected expansion ratio. In various embodiments, an unconventionally large expansion ratio is chosen to extract virtually all useable heat and pressure from the combustion chamber before the exhaust valve opens, resulting in a comparatively cool and quiet exhaust stroke with minimal exhaust duct flow velocity. The DCR can be referred to as the “compression ratio”, and the DER referred to as the “expansion ratio”. If the 4-stroke IPC engine has a 100 mm piston stroke, the expansion stroke occupies 100 mm of piston travel after TDC, and the 15:1 compression stroke begins 50 mm BTC. The 15:1 compression ratio is independent of the 30:1 expansion ratio. In one embodiment, the intake cycle for a 4-stroke IPC engine occupies only the first 50 mm of piston travel after TDC and the compression stroke occupies the final 50 mm of piston travel before TDC. Combustion chamber pressure will drop as low as 0.50̂1.4=0.38 bar in the period between the end of the intake stroke and the start of the compression stroke. The described intake stroke can have a valve train configuration with an unusually large camshaft base circle. Another embodiment for the 4-stroke IPC engine incorporates the Atkinson reversion cycle, in which the intake stroke occupies the entire 100 mm of piston travel from TDC to BDC, and as the piston then rises from BDC the inducted air flows out the intake duct until the intake valve closes at 50 mm BTC.

### 4-Stroke IPC Engine Sequence

According to various embodiments, a 4-stroke IPC full engine cycle includes twelve stages of operation including: 1) Intake, 2) Vacuum, 3) Rebound, 4) Compression, 5) Injection, 6) Turbulence, 7) Ignition, 8) Combustion, 9) Expansion, 10) Vacuum, 11) Rebound, and 12) Exhaust. One embodiment of the engine cycle includes the following sequence:

04 mm ATC: Intake valve opens, drawing in unthrottled air, same as a Diesel engine.
50 mm ATC: Induction cycle ends, intake valve closes.
51 mm ATC: Cylinder begins pulling a vacuum as piston continues toward BDC.
100 mm BDC: Combustion chamber drops to 0.50̂1.4=0.38 bar pressure.
99 mm BTC: Piston elastically rebounds off vacuum and is pulled toward TDC.
50 mm BTC: Vacuum rebound ends, compression of inducted air begins.
49 mm BTC: Inducted air begins adiabatically heating in combustion chamber.
12 mm BTC: Combustion chamber transitions to become stratified.
09 mm BTC: Combustion chamber becomes predominantly thermally insulating.
08 mm BTC: Fuel is direct injected toward pocket at center of piston.
07 mm BTC: Crevice chamber pumps fresh air toward piston pocket, constraining fuel.
06 mm BTC: Direct fuel injection ends.
05 mm BTC: Air from perimeter region generates turbulence in central combustion region
01 mm BTC: Fuel and air homogenously mixed in central combustion region.
0.5 mm BTC: Spark ignites fuel and air mixture, combustion progresses rapidly.
00 mm TDC: Combustion reaction expands into annular transfer passage.
0.3 mm ATC: Annular transfer passage forces pure air back into perimeter region.
0.5 mm ATC: Combustion reaction extinguishes.
05 mm ATC: Combusted gasses are adiabatically cooling in combustion chamber.
09 mm ATC: Combustion chamber first exposes thermally conductive cylinder bore.
12 mm ATC: Stratified combustion chamber transitions to become single chamber.
75 mm ATC: Combustion chamber starts pulling a vacuum (low throttle only).
87 mm ATC: Combustion chamber starts pulling a vacuum (mid throttle only).
99 mm ATC: Combustion chamber pressure drops to 1.3 bar (full throttle only).
100 mm BDC: Combustion chamber pressure or vacuum depends on throttle position.
99 mm BTC: Expansion stroke ends, exhaust valve opens (full throttle only).
87 mm BTC: Combustion chamber vacuum ends, exhaust valve opens (mid throttle only).
75 mm BTC: Combustion chamber vacuum ends, exhaust valve opens (low throttle only).
04 mm BTC: Exhaust valve closes.
04 mm ATC: Intake valve opens, drawing in unthrottled air, same as a Diesel engine.

In one embodiment, the 4-stroke IPC engine described above can be cost-reduced to employ a simpler, slightly less thermally efficient Atkinson reversion cycle which follows the sequence:

04 mm ATC: Intake valve opens, drawing in unthrottled air, same as Diesel engine.
100 mm BDC: Induction cycle ends, Atkinson reversion cycle begins.
50 mm BTC: Intake valve closes, Atkinson reversion ends, compression cycle begins.
49 mm BTC: Fresh air begins adiabatically heating in combustion chamber.
12 mm BTC: Combustion chamber transitions to become stratified.
09 mm BTC: Combustion chamber becomes predominantly thermally insulating.
08 mm BTC: Fuel is direct injected toward pocket at center of piston.
07 mm BTC: Crevice chamber pumps fresh air toward piston pocket, constraining fuel.
06 mm BTC: Direct fuel injection ends.
05 mm BTC: Air from perimeter region generates turbulence in central combustion region
01 mm BTC: Fuel and air homogenously mixed in central combustion region.
0.5 mm BTC: Spark ignites fuel and air mixture, combustion progresses rapidly.
00 mm TDC: Combustion reaction expands into annular transfer passage.
0.3 mm ATC: Annular transfer passage forces pure air back into perimeter region.
0.5 mm ATC: Combustion reaction extinguishes.
05 mm ATC: Combusted gasses are adiabatically cooling in combustion chamber.
09 mm ATC: Combustion chamber first exposes thermally conductive cylinder bore.
12 mm ATC: Stratified combustion chamber transitions to become single chamber.
50 mm ATC: Conventional expansion cycle ends, Atkinson expansion cycle begins.
100 mm BDC: Atkinson expansion cycle ends, exhaust valve opens, exhaust cycle begins.
04 mm BTC: Exhaust valve closes, exhaust cycle ends.
04 mm ATC: Intake valve opens, drawing in unthrottled air, same as Diesel engine.

### 2-Stroke IPC Engine Sequence

According to an embodiment, a 2-stroke IPC engine incorporates an engine operating sequence summarized as follows:

### 1) Compression—33 mm BTC to 0.5 mm BTC

### 2) Ignition—0.5 mm BTC

### 3) Combustion—0.5 mm BTC to 0.5 mm ATC

### 4) Expansion—0.5 mm ATC to 67 mm ATC

### 5) Induction—67 mm ATC to 90 mm BTC

### 6) Exhaustion—90 mm BTC to 33 mm BTC

According to one embodiment of a 2-stroke IPC engine, exhaust valves are included in the head, and the operating sequence includes:

33 mm BTC: Exhaust valve closes, compression of fresh air and some exhaust begins.
32 mm BTC: Fresh air begins adiabatically heating.
12 mm BTC: Combustion chamber transitions to become stratified.
09 mm BTC: Combustion chamber becomes predominantly thermally insulating.
08 mm BTC: Fuel is direct injected toward pocket at center of piston.
07 mm BTC: Crevice chamber pumps fresh air toward piston pocket, constraining fuel.
06 mm BTC: Direct fuel injection ends.
05 mm BTC: Air from perimeter region generates turbulence in central combustion region
01 mm BTC: Fuel and air homogenously mixed in central combustion region.
0.5 mm BTC: Spark ignites fuel and air mixture, combustion progresses rapidly.
00 mm TDC: Combustion reaction expands into annular transfer passage.
0.3 mm ATC: Annular transfer passage forces pure air back into perimeter region.
0.5 mm ATC: Combustion reaction extinguishes.
05 mm ATC: Combusted gasses are adiabatically cooling in combustion chamber.
09 mm ATC: Combustion chamber first exposes thermally conductive cylinder bore.
12 mm ATC: Stratified combustion chamber transitions to become single chamber.
33 mm ATC: Conventional expansion cycle ends, Atkinson expansion cycle begins.
66 mm ATC: Combustion chamber pressure reaches latm.
67 mm ATC: Intake port becomes visible to combustion chamber.
68 mm ATC: Vacuum forms and pulls fresh air into lower third of combustion chamber.
69 mm ATC: Upper 67 mm of chamber contains gasses with ¼ of oxygen consumed.
90 mm ATC: Exhaust valves in head begin to open.
100 mm BDC: Intake ports are fully visible to combustion chamber.
99 mm BTC: Lower 33 mm of combustion chamber contains air, upper 67 mm contains exhaust.
90 mm BTC: Intake ports in cylinder bore become blocked by rotating drum valve assy.
89 mm BTC: Piston pushes combusted gasses in upper chamber into exhaust duct.
33 mm BTC: Exhaust valves close, compression of fresh air and some exhaust begins.

Another version of the 2-stroke IPC engine incorporates a rotary drum valve, and the engine operates in a sequence summarized as follows:

### 1) Compression—33 mm BTC to 0.5 mm BTC

### 2) Ignition—0.5 mm BTC

### 3) Combustion—0.5 mm BTC to 0.5 mm ATC

### 4) Expansion—0.5 mm ATC to 67 mm ATC

### 5) Induction and Exhaustion—67 mm ATC to 33 mm BTC

This version of the 2-stroke IPC engine contains no poppet valves in the head. Instead, this IPC engine uses intake ports on one side of the cylinder block, and exhaust ports on the opposite side of the cylinder block. The intake ports are organized into an upper bank of ports and a lower bank of ports in which the rotary drum valve acts as a shutter and also acts as a blower. The exhaust side of the cylinder block is similarly configured, except the rotary drum valve assembly acts as a vacuum pump. Induction and exhaustion occur simultaneously, flowing across the combustion chamber with sufficient chaos that combusted gasses throughout the combustion chamber are substantially replaced with inducted air. The detailed operating sequence is as follows:

33 mm BTC: Exhaust port sealed by piston ring, compression begins.
32 mm BTC: Fresh air begins adiabatically heating.
12 mm BTC: Combustion chamber transitions to become stratified.
09 mm BTC: Combustion chamber becomes predominantly thermally insulating.
08 mm BTC: Fuel is direct injected toward pocket at center of piston.
07 mm BTC: Crevice chamber pumps fresh air toward piston pocket, constraining fuel.
06 mm BTC: Direct fuel injection ends.
05 mm BTC: Air from perimeter region generates turbulence in central combustion region
01 mm BTC: Fuel and air homogenously mixed in central combustion region.
0.5 mm BTC: Spark ignites fuel and air mixture, combustion progresses rapidly.
00 mm TDC: Combustion reaction expands into annular transfer passage.
0.3 mm ATC: Annular transfer passage forces pure air back into perimeter region.
0.5 mm ATC: Combustion reaction extinguishes.
05 mm ATC: Combusted gasses are adiabatically cooling in combustion chamber.
09 mm ATC: Combustion chamber first exposes thermally conductive cylinder bore.
12 mm ATC: Stratified combustion chamber transitions to become single chamber.
33 mm ATC: Upper intake and exhaust ports first enter chamber but are shuttered closed.
50 mm ATC: Upper intake and exhaust ports remain shuttered but are fully in chamber.
67 mm ATC: Lower intake and exhaust ports first become exposed to chamber.
68 mm ATC: Cross-flow of inducted and exhausted gasses begins in chamber.
69 mm ATC: Upper ports begin to unshutter and begin to cross-flow.
90 mm ATC: All intake and exhaust ports are now unshuttered and cross-flowing.
100 mm BDC: Lower intake and exhaust ports fully visible to combustion chamber.
90 mm BTC: Intake ports become blocked by rotary drum valve assembly.
89 mm BDC: Piston pushes combustion chamber gasses out exhaust ports.
33 mm BTC: Exhaust port sealed by piston rings, compression begins.

According to one embodiment, the 2-stroke IPC engine places the previously described intake and exhaust ports on the same side of the cylinder block, with a single rotary drum valve assembly modified to provide both induction and exhaustion, and with the externally visible surfaces of the rotary drum valve assembly acting on the induction gasses and the internally visible surfaces of the rotary drum valve assembly acting on the exhaust gasses. This results in a low-cost 2-stroke IPC engine.

This application is intended to cover adaptations or variations of the present subject matter. It is to be understood that the above description is intended to be illustrative, and not restrictive. The scope of the present subject matter should be determined with reference to the appended claims, along with the full scope of legal equivalents to which such claims are entitled.

What is claimed is:

1. A combustion chamber assembly, comprising:
a cylinder head assembly including an internal bore, an open end, a closed end, and an external block;
a piston assembly adapted to reciprocate within the internal bore between a top dead center (TDC) position near the closed end and a bottom dead center (BDC) position, the piston assembly having a compression end facing the closed end, an outside diameter, a groove located at the outside diameter a crevice distance from the compression end, and a sealing ring positioned in the groove;
a combustion chamber bounded by the compression end, the closed end, and the internal bore, and whose volume is dependent on the position of the compression end, wherein the combustion chamber is adapted to transition from unstratified to stratified each time the compression end travels from BDC toward TDC and reaches a stratified distance from the closed end, and the combustion chamber is adapted to transition from stratified to unstratified each time the compression end travels from TDC toward BDC and reaches the stratified distance from the closed end, and wherein the combustion chamber, when stratified, includes a central combustion region, a perimeter squish region, and a transfer passage between the central region and the perimeter squish region, where a sum of volumes of these regions and passage equals a volume of the combustion chamber, and when unstratified includes a single region, where a volume of the single region equals the volume of the combustion chamber; and
a direct fuel injector mounted to the closed end and, when the combustion chamber is stratified, the direct fuel injector is positioned to inject fuel into the central combustion region,
wherein the perimeter squish region includes a portion of the internal bore which is bounded by the compression end and closed end, and wherein the transfer passage is adapted to transfer gasses from the perimeter squish region to the central combustion region prior to the start of combustion.

2. The combustion chamber assembly of claim 1 wherein the transfer passage is adapted to constrain direct injected fuel to the central combustion region.

3. The combustion chamber assembly of claim 1, further comprising an intake poppet valve on the closed end, or an intake port between the internal bore and external block, to control the flow of gasses into the combustion chamber.

4. The combustion chamber assembly of claim 3, further comprising a rotary drum valve assembly at the external block, the rotary drum valve assembly adapted to control the direction of the flow of gasses into the combustion chamber, in which gasses only contact external surfaces of the rotary drum valve assembly.

5. The combustion chamber assembly of claim 3, further comprising an exhaust poppet valve on the closed end, or an exhaust port between the internal bore and external block, to control the flow of gasses from the combustion chamber.

6. The combustion chamber assembly of claim 5, further comprising a rotary drum valve assembly at the external block, the rotary drum valve assembly adapted to control the direction of the flow of gasses from the combustion chamber, in which gasses only contact external surfaces of the rotary drum valve assembly.

7. The combustion chamber assembly of claim 5, further comprising a rotary drum valve assembly at the external block, the rotary drum valve assembly adapted to control the direction of the flow of gasses from the combustion chamber, in which gasses only contact internal surfaces of the rotary drum valve assembly.

8. The combustion chamber assembly of claim 1, further comprising a layer of combustion-resistant thermally insulating material affixed to the compression end.

9. The combustion chamber assembly of claim 8, further comprising a layer of combustion-resistant thermally insulating material affixed to the closed end.

10. The combustion chamber assembly of claim 9, wherein the combustion-resistant thermally insulating material on the closed end covers substantially a portion of a surface of the closed end occupied by the central combustion region and transfer passage.

11. The combustion chamber assembly of claim 9, wherein the combustion-resistant thermally insulating material on the closed end covers substantially an entire surface of the closed end, but does not cover valves or the direct fuel injector.

12. A method of operating an internal combustion engine, the method comprising:
reciprocating a piston assembly between a top dead center (TDC) position and a bottom dead center (BDC) position within an internal bore of a cylinder head assembly having an open end and a closed end, the piston assembly having a compression end facing the closed end;
forming a combustion chamber including a central combustion region, a perimeter squish region, and a transfer passage between the central combustion region and the perimeter squish region, each time the compression end reaches a stratified distance from the closed end while traveling from BDC toward TDC; and
forming the combustion chamber including a single region each time the compression end reaches the stratified distance from the closed end while traveling away from TDC.

13. The method of claim 12, further comprising transferring inducted gasses from the perimeter squish region to the central combustion region via the transfer passage prior to combustion.

14. The method of claim 12, wherein the transfer passage includes an annular transfer passage.

15. The method of claim 12, further comprising affixing a layer of combustion-resistant thermally insulating material affixed to at least a portion of the closed end and the compression end.

16. The method of claim 15, further comprising transitioning the combustion chamber from partially insulating to predominantly thermally insulating at an insulation distance BTC.

17. The method of claim 16, wherein the stratified distance is approximately 12 mm and the insulation distance is approximately 9 mm.

18. The method of claim 17, further comprising initiating direct fuel injection 8 mm BTC and completing direct fuel injection at or before 6 mm BTC.

19. The method of claim 12, further comprising providing a period of turbulent fuel-air mixing in the central combustion region from the end of direct fuel injection until combustion begins, with turbulent kinetic energy (TKE) substantially provided by transfer of inducted gasses from the perimeter squish region to the central combustion region.

20. The method of claim 12, further comprising combusting fuel at a fuel-air equivalence ratio of approximately 0.38 to 0.75.
